(19) United States
(12) Patent Application Publication
(10) Pub. No.: US 2024/0406946 A1
(43) Pub. Date: Dec. 5, 2024

(54) WIRELESS COMMUNICATION METHOD, USER EQUIPMENT, AND BASE STATION

(71) Applicant: Huizhou TCL Cloud Internet Corporation Technology Co., Ltd., Huizhou, Guangdong (CN)

(72) Inventors: Yiwei DENG, Huizhou, Guangdong (CN); Jia SHENG, Huizhou, Guangdong (CN); Aijuan FENG, Huizhou, Guangdong (CN)

(73) Assignee: Huizhou TCL Cloud Internet Corporation Technology Co., Ltd., Huizhou, Guangdong (CN)

(21) Appl. No.: 18/695,005

(22) PCT Filed: Sep. 30, 2021
(86) PCT No.: PCT/CN2021/122388

§ 371 Date: Mar. 25, 2024

(51) Int. Cl. H04W 72/11; H04L 1/1867; H04W 72/0446; H04W 72/23

(52) U.S. Cl. CPC H04W 72/11; H04L 1/1896; H04W 72/0446; H04W 72/23

(57) ABSTRACT

A wireless communication method executable in a base station (BS) includes: modifying at least one parameter of a configured grant (CG) transmission or modifying at least one parameter of a semi-persistent scheduling (SPS) transmission; and configuring the at least one modified parameter of the CG transmission to a user equipment (UE) or configuring the at least one modified parameter of the SPS transmission to the UE.

### TECHNICAL FIELD

The present disclosure relates to the field of communication systems, and more particularly, to a wireless communication method, a user equipment, and a base station.

### BACKGROUND ART

Extended reality (XR) and cloud gaming are some of the most important 5th generation mobile networks (5G) media applications under consideration in the industry. XR is an umbrella term for different types of realities and refers to all real-and-virtual combined environments and human-machine interactions generated by computer technology and wearables. XR includes representative forms such as augmented reality (AR), mixed reality (MR), and virtual reality (VR) and the areas interpolated among them. A new study item description (SID) on XR evaluation has been approved. The characteristics of XR traffic and challenges are summarized as follows.

First, for different frame types, video frame sizes are varying due to different compression rates. Even for a fixed frame type, video frame sizes are also varying over time due to different compression rates based on the content of video frames. In addition, channel states are changed with time going, and semi-static configured parameters should not be satisfied with the changes of the channel states.

Second, according to discussion on traffic model, a mean packet size is very large. In order to transmit a packet with a large transport block size (TBS), more than one slot in a time domain is required. However, if an XR transmission is based on a dynamic grant (DG), downlink control information (DCI) overhead will be large.

Third, it has been agreed that 60 frames per second (fps) is a baseline for both downlink (DL) and uplink (UL) video streams. Furthermore, 30 fps, 90 fps as well as 120 fps can be also optionally evaluated. Based on the formula of arrival time of a packet, corresponding periodicities are {33.33 ms, 16.67 ms, 11.11 ms, 8.33 ms}. In addition, there exists jitter characteristic for an XR traffic arrival. However, the periodicity of semi-persistent scheduling (SPS) in the current specification can only be an integer number of slots. That is, there is a gap between an XR service arrival and an SPS periodicity. In addition, Configured grant (CG) transmission has similar problems.

### TECHNICAL PROBLEM

In XR applications or services, video frame sizes are also varying over time due to different compression rates, and thus some semi-static configured parameters for CG/SPS should not be suitable for XR services. Furthermore, if an XR transmission is based on a DG, DCI overhead will be large. Finally, there is a gap between an XR service arrival and an SPS (or CG) periodicity.

### TECHNICAL SOLUTION

An object of the present disclosure is to propose a wireless communication method, a user equipment, and a base station.

A first aspect of the present disclosure provides a wireless communication method executable in a base station (BS), including: modifying at least one parameter of a configured grant (CG) transmission or modifying at least one parameter of a semi-persistent scheduling (SPS) transmission; and configuring the at least one modified parameter of the CG transmission to a user equipment (UE) or configuring the at least one modified parameter of the SPS transmission to the UE.

A second aspect of the present disclosure provides a wireless communication method executable in a base station (BS), including: configuring several fields with a varying size in downlink control information (DCI) for a plurality of transport blocks (TBs); and transmitting the DCI to a user equipment (UE).

A third aspect of the present disclosure provides a wireless communication method executable in a base station (BS), including: configuring a set of time offsets to indicate at least one time value for delaying a periodicity of a transmission occasion of a configured grant (CG) or a periodicity of a transmission occasion of a semi-persistent scheduling (SPS); and transmitting the set of time offsets to a user equipment (UE).

A fourth aspect of the present disclosure provides a wireless communication method executable in a user equipment (UE), including: receiving at least one modified parameter of a configured grant (CG) transmission or receiving at least one modified parameter of a semi-persistent scheduling (SPS) transmission.

A fifth aspect of the present disclosure provides a wireless communication method executable in a user equipment (UE), including: receiving downlink control information (DCI), wherein several fields with a varying size are configured in the DCI for a plurality of transport blocks (TBs).

A sixth aspect of the present disclosure provides a wireless communication method executable in a user equipment (UE), including: receiving a set of time offsets, wherein the set of time offsets are configured to indicate at least one time value for delaying a periodicity of a transmission occasion of a configured grant (CG) or a periodicity of a transmission occasion of a semi-persistent scheduling (SPS).

A seventh aspect of the present disclosure provides a base station (BS), including: a transceiver; and a processor connected with the transceiver and configured to execute operations including: modifying at least one parameter of a configured grant (CG) transmission or modifying at least one parameter of a semi-persistent scheduling (SPS) transmission; and configuring the at least one modified parameter of the CG transmission to a user equipment (UE) or configuring the at least one modified parameter of the SPS transmission to the UE.

An eighth aspect of the present disclosure provides a base station (BS), including: a transceiver; and a processor connected with the transceiver and configured to execute operations including: configuring several fields with a varying size in downlink control information (DCI) for a plurality of transport blocks (TBs); and transmitting the DCI to a user equipment (UE).

A ninth aspect of the present disclosure provides a base station (BS), including: a transceiver; and a processor connected with the transceiver and configured to execute operations including: configuring a set of time offsets to indicate at least one time value for delaying a periodicity of a transmission occasion of a configured grant (CG) or a periodicity of a transmission occasion of a semi-persistent scheduling (SPS); and transmitting the set of time offsets to a user equipment (UE).

A tenth aspect of the present disclosure provides a user equipment (UE) including: a transceiver; and a processor connected with the transceiver and configured to execute an operation including: receiving at least one modified parameter of a configured grant (CG) transmission or receiving at least one parameter of a semi-persistent scheduling (SPS) transmission.

An eleventh aspect of the present disclosure provides a user equipment (UE) including: a transceiver; and a processor connected with the transceiver and configured to execute an operation including: receiving downlink control information (DCI), wherein several fields with a varying size are configured in the DCI for a plurality of transport blocks (TBs).

A twelfth aspect of the present disclosure provides a user equipment (UE) including: a transceiver; and a processor connected with the transceiver and configured to execute an operation including: receiving a set of time offsets, wherein the set of time offsets are configured to indicate at least one time value for delaying a periodicity of a transmission occasion of a configured grant (CG) or a periodicity of a transmission occasion of a semi-persistent scheduling (SPS).

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as computer program product that causes a computer to execute the disclosed method.

The disclosed method may be programmed as computer program that causes a computer to execute the disclosed method.

### ADVANTAGEOUS EFFECTS

The present disclosure can solve the problems that some semi-static configured parameters for CG/SPS should not be suitable for XR services, the DCI overhead is large when an XR transmission is based on a DG, and there is a gap between an XR service arrival and an SPS (or CG) periodicity.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram showing a telecommunication system.

FIG. 2 is a schematic diagram showing an extended reality (XR) service and a CG/SPS transmission occasion.

FIG. 3 is a schematic diagram showing a wireless communication method executable in a base station (BS) according to an embodiment of the present disclosure.

FIG. 4 is a schematic diagram showing a wireless communication method executable in a base station (B S) according to an embodiment of the present disclosure.

FIG. 5 is a schematic diagram showing DCI scheduling multiple PDSCHs according to an embodiment of the present disclosure when the sizes of the multiple PDSCHs are different.

FIG. 6 is a schematic diagram showing DCI scheduling multiple PDSCHs with MCSs according to an embodiment of the present disclosure when the sizes of the multiple PDSCHs are different.

FIG. 7 is a schematic diagram showing HARQ feedbacks for multiple PDSCHs.

FIG. 8 is a schematic diagram showing a wireless communication method executable in a base station (BS) according to an embodiment of the present disclosure.

FIG. 9 is a schematic diagram showing a gap between a CG periodicity and an XR service arrival according to an embodiment of the present disclosure.

FIG. 10 is a schematic diagram showing a wireless communication method executable in a user equipment (UE) according to an embodiment of the present disclosure.

FIG. 11 is a schematic diagram showing a wireless communication method executable in a user equipment (UE) according to an embodiment of the present disclosure.

FIG. 12 is a schematic diagram showing a wireless communication method executable in a user equipment (UE) according to an embodiment of the present disclosure.

FIG. 13 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the present disclosure.

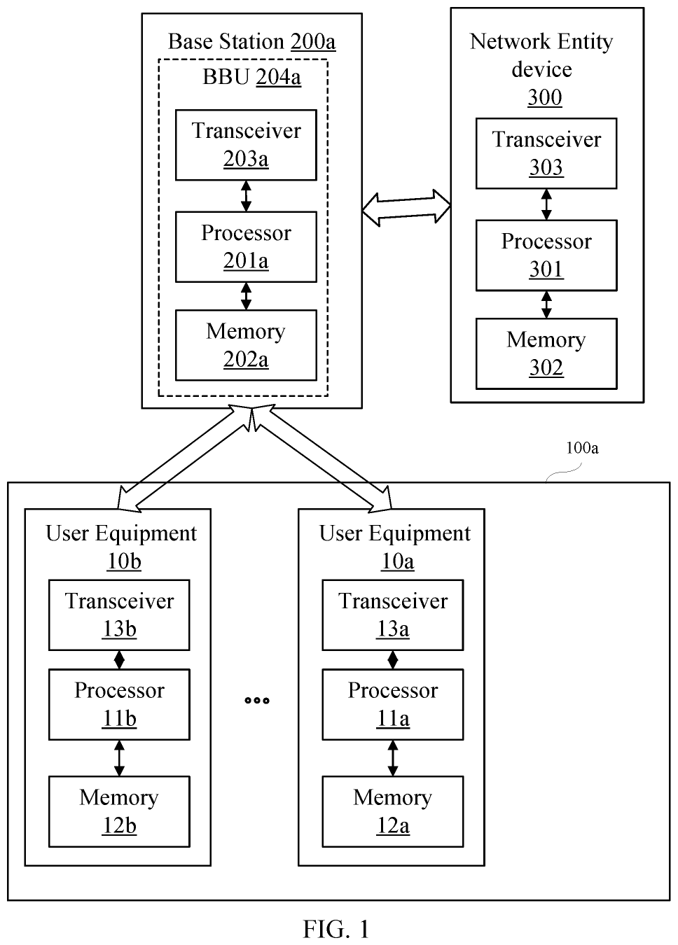

With reference to FIG. 1, a telecommunication system including a group 100a of a plurality of UEs, a base station (BS) 200a, and a network entity device 300 executes the disclosed method according to an embodiment of the present disclosure. The group 100a of a plurality of UEs may include a UE 10a, a UE 10b, and other UEs. FIG. 1 is shown for illustrative not limiting, and the system may include more UEs, BSs, and CN entities. Connections between devices and device components are shown as lines and arrows in the figure. Connections between devices may be realized by wireless connections. Connections between device components may be realized by wirelines, buses, traces, cables or optical fabrics. The UE 10a may include a processor 11a, a memory 12a, and a transceiver 13a. The UE 10b may include a processor 11b, a memory 12b, and a transceiver 13b. The base station 200a may include a baseband unit (BBU) 204a. The base band unit 204a may include a processor 201a, a memory 202a, and a transceiver 203a. The network entity device 300 may include a processor 301, a memory 302, and a transceiver 303. Each of the processors 11a, 11b, 201a, and 301 may be configured to implement proposed functions, procedures and/or methods described in the description. Layers of radio interface protocol may be implemented in the processors 11a, 11b, 201a, and 301. Each of the memories 12a, 12b, 202a, and 302 operatively stores a variety of programs and information to operate a connected processor. Each of the transceivers 13a, 13b, 203a, and 303 is operatively coupled with a connected processor, transmits and/or receives radio signals or wireline signals. The UE 10a may be in communication with the UE 10b through a sidelink. The base station 200a may be an eNB, a gNB, or one of other types of radio nodes.

Each of the processors 11a, 11b, 201a, and 301 may include a central processing unit (CPU), an application-specific integrated circuits (ASICs), other chipsets, logic circuits and/or data processing devices. Each of the memories 12a, 12b, 202a, and 302 may include a read-only memory (ROM), a random access memory (RAM), a flash memory, a memory card, a storage medium and/or other storage devices. Each of the transceivers 13a, 13b, 203a, and 303 may include baseband circuitry and radio frequency (RF) circuitry to process radio frequency signals. When the embodiments are implemented in software, the techniques described herein can be implemented with modules, units, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 300 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and network exposure function (NEF).

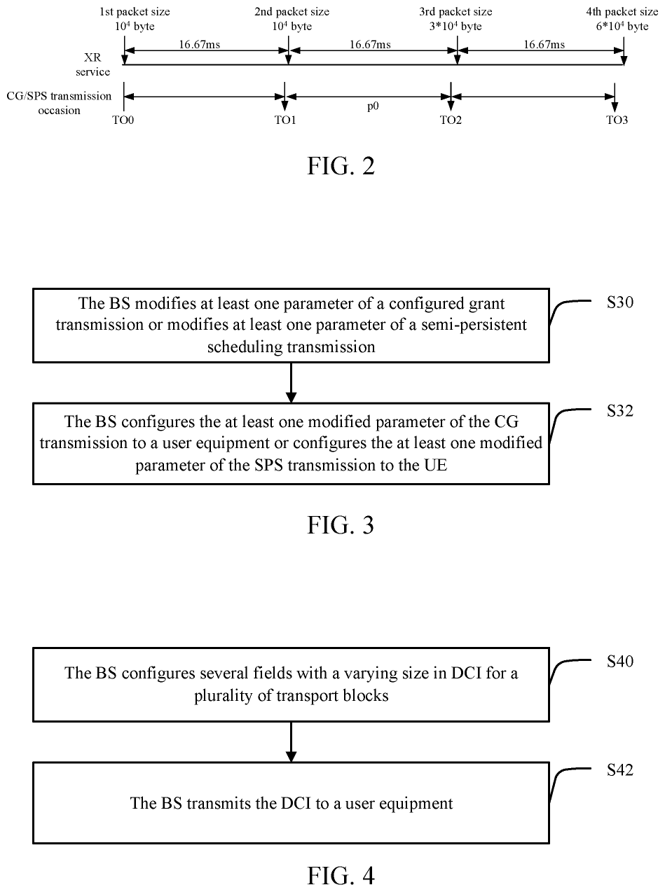

For different frame types, video frame sizes are varying due to different compression rates. Even for a fixed frame type, video frame sizes are also varying over time due to different compression rates based on the content of video frames. Semi-static configured parameters for configured grant/semi-persistent scheduling (CG/SPS) should not be always suitable for XR services. Please refer to FIG. 2. FIG. 2 is a schematic diagram showing an extended reality (XR) service and a CG/SPS transmission occasion. When the CG/SPS transmission occasion is configured based on a first arrival packet of the XR service, resources configured for the CG/SPS transmission occasion is not suitable for a third arrival packet and a fourth arrival packet of the XR service. That is, the CG/SPS transmission occasion shouldn't be transmitted the packet timely. The delay of the XR service can be exceeded. In Release-16, multiple CG/SPS configurations have been agreed. However, reserving large resources for a UE is not an efficient way for a system. The present disclosure provides a wireless communication method for solving the problem in type 1 CG transmissions and type 2 CG transmissions.

Please refer to FIG. 3. FIG. 3 is a schematic diagram showing a wireless communication method executable in a base station (BS) according to an embodiment of the present disclosure.

In step S30, the BS modifies at least one parameter of a configured grant (CG) transmission or modifies at least one parameter of a semi-persistent scheduling (SPS) transmission.

In step S32, the BS configures the at least one modified parameter of the CG transmission to a user equipment (UE) or configures the at least one modified parameter of the SPS transmission to the UE.

In Release-15/16, type 1 CG is introduced for new radio (NR), a ConfiguredCrantConfig and an rrc-ConfiguredUplinkGrant should be configured to a UE for a CG type 1 config. When some parameters for the type 1 CG need to be modified, RRC re-configure should be used. However, long latency is caused due to the RRC re-configure. Accordingly, a dynamic way to modify some parameters of the type 1 CG should be needed.

For a type 1 CG transmission, the present disclosure provides three methods for modifying the at least one parameter of the type 1 CG transmission.

In one embodiment, the BS uses a medium access control element (MAC-CE) to modify the at least one parameter of the type 1 CG transmission.

For example, at least one of the following parameters can be modified by the MAC-CE:
mcs-Table
resourceAllocation
rbg-Size
p0-PUSCH-Alpha
nrofHARQ-Processes
periodicity
repK
timeDomainOffset
timeDomainAllocation
frequencyDomainAllocation
antennaPort
precodingAndNumberOfLayers

It is noted the above-mentioned parameters are well known in the prior art and detailed explanations are not repeated herein.

In another embodiment, the BS uses a new radio network temporary identifier (RNTI) scrambled downlink control information (DCI) format to modify the at least one parameter of the type 1 CG transmission. In detail, the BS uses the new RNTI scrambled DCI format 0-0/0-1/0-2 to modify the at least one parameter of the type 1 CG transmission.

For example, at least one of the following parameters can be modified by the new RNTI scrambled DCI format:
mcs-Table
resourceAllocation
rbg-Size
p0-PUSCH-Alpha
nrofHARQ-Processes
periodicity
repK
timeDomainOffset
timeDomainAllocation
frequencyDomainAllocation
antennaPort
precodingAndNumberOfLayers

It is noted the above-mentioned parameters are well known in the prior art and detailed explanations are not repeated herein.

In yet another embodiment of the present disclosure, the BS uses a new DCI format to modify the at least one parameter of the type 1 CG transmission.

For example, at least one of the following parameters can be modified by the new DCI format:
mcs-Table
resourceAllocation
rbg-Size
p0-PUSCH-Alpha
nrofHARQ-Processes
periodicity
repK
timeDomainOffset
timeDomainAllocation
frequencyDomainAllocation
antennaPort
precodingAndNumberOfLayers

It is noted the above-mentioned parameters are well known in the prior art and detailed explanations are not repeated herein.

In Release 15/16, a ConfiguredGrantConfig and an SPS-Config should be configured to a UE respectively, and a DCI scrambled by a configured scheduling-radio network temporary identifier (CS-RNTI) should be used to activate a CG configuration or an SPS configuration. Generally speaking, when some parameters (e.g. frequency-domain resource allocation (FDRA), time-domain resource allocation (TDRA), or modulation coding scheme (MCS) of CG/SPS) need to be modified, a CS-RNTI scrambled DCI can be used for re-activate the CG/SPS. However, in one hand, the periodicity of CG/SPS configured semi-static cannot be modified by the re-activeta DCI. In another hand, only part of parameters of CG/SPS needs to modify. That is, the size of DCI for modifying some parameters of CG/SPS is smaller than a regular DCI size.

For a type 2 CG transmission or SPS transmission, the present disclosure provides two methods for modifying the at least one parameter of the type 2 CG transmission or the at least one parameter of the SPS transmission.

In one embodiment, the BS uses a MAC-CE to modify the at least one parameter of the type 2 CG transmission or the at least one parameter of the SPS transmission.

It is noted that the parameters which can be modified by MAC-CE for the type 2 CG transmission or the SPS transmission can be referred to the type 1 CG transmission described above and are not repeated herein.

In another embodiment, the BS uses a new DCI to modify the at least one parameter of the type 2 CG transmission or the at least one parameter of the SPS transmission.

It is noted that the parameters which can be modified by the new DCI for the type 2 CG transmission or the SPS transmission can be referred to the type 1 CG transmission described above and are not repeated herein.

By modifying semi-static configured parameters for CG/SPS transmissions dynamically, an XR service can be matched the CG/SPS transmissions.

According to discussion on a traffic model, a mean packet size is very large. Taking AR/VR 30 million bits per second (Mbps) as an example, a mean packet size is 62500 bytes. In order to transmit this packet with a large transport Block Size (TBS), more than one slot in a time domain is required. However, if an XR transmission is based on a dynamic grant (DG), downlink control information (DCI) overhead will be large.

Please refer to FIG. 4. FIG. 4 is a schematic diagram showing a wireless communication method executable in a base station (BS) according to an embodiment of the present disclosure for solving the problem that DCI overhead is large.

In step S40, the BS configures several fields with a varying size in DCI for a plurality of transport blocks (TBs).

The TBs can be physical downlink shared channel (PDSCH) transmissions or physical uplink shared channel (PUSCH) transmissions.

In step S42, the BS transmits the DCI to a user equipment (UE).

The plurality of TBs are configured with fixed fields within the DCI, and a number of the TBs is indicated by radio resource control (RRC), a medium access control element (MAC-CE) or the DCI. Furthermore, there is a combination between the several fields with the varying size in the DCI and the TBs.

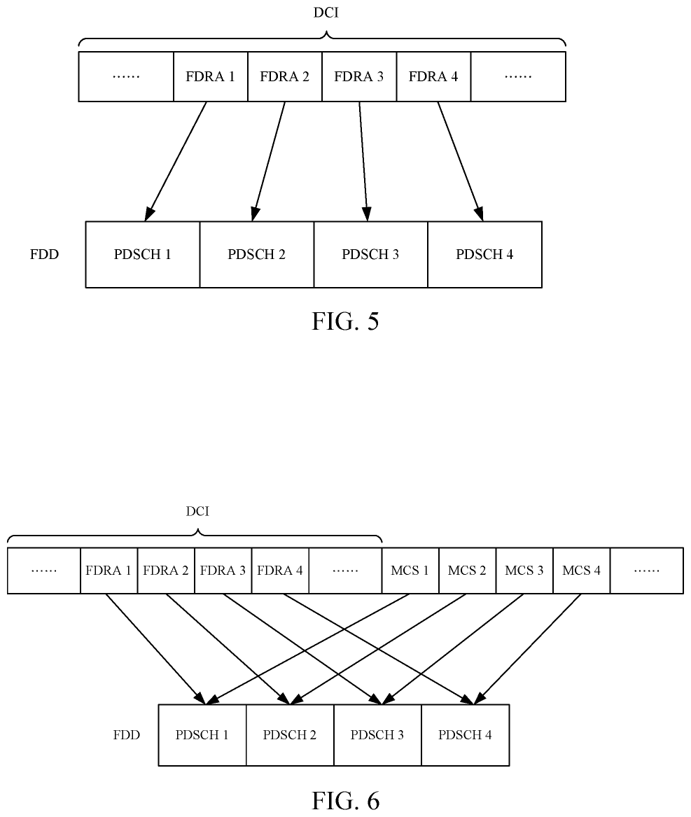

Please refer to FIG. 5. FIG. 5 is a schematic diagram showing DCI scheduling multiple PDSCHs according to an embodiment of the present disclosure when the sizes of the multiple PDSCHs are different. An architecture shown in FIG. 5 is a frequency division duplex (FDD) frame structure.

In the present embodiment, some fields within the DCI are configurable (e.g., (frequency-domain resource allocation (FDRA) or modulation coding scheme (MCS)). The fields at least include a resource allocation field, and resource allocations of the TBs are respectively indicated by an independent part of the resource allocation field in the DCI. The number of PDSCHs scheduled by the DCI is equal to a size of the independent fields. Taking the DCI scheduling multiple PDSCHs with different frequency resources as an example, the DCI schedules 4 PDSCHs, and thus 4 independent FDRA fields in the DCI are needed.

As shown in FIG. 4, the first FDRA field is denoted as FDRA 1, and the first PDSCH transmission is denoted as PDSCH 1. The second FDRA field is denoted as FDRA 2, and the second PDSCH transmission is denoted as PDSCH 2. The third FDRA field is denoted as FDRA 3, and the third PDSCH transmission is denoted as PDSCH 3. The fourth FDRA field is denoted as FDRA 4, and the fourth PDSCH transmission is denoted as PDSCH 4. The resource allocation of the PDSCH 1 is indicated by the FDRA 1, the resource allocation of the PDSCH 2 is indicated by the FDRA 2, the resource allocation of the PDSCH 3 is indicated by the FDRA 3, and the resource allocation of the PDSCH 4 is indicated by the FDRA 4. The remaining parameters are common for all of the PDSCHs 1-4. As shown in FIG. 5, the PDSCHs 1-4 (i.e., the TBs) are continuously transmitted transmissions. In detail, the PDSCHs 1-4 are continuously transmitted back to back. In summary, the TBs are continuously mapped to available slots or mini-slots, and the slots or mini-slots of TBs mapped can be consecutive or non-consecutive.

It is noted that the embodiment in FIG. 5 can also be used for a time division duplex (TDD) frame structure and PUSCH transmissions.

Please refer to FIG. 6. FIG. 6 is a schematic diagram showing DCI scheduling multiple PDSCHs with MCSs according to an embodiment of the present disclosure when the sizes of the multiple PDSCHs are different. An architecture shown in FIG. 6 is a frequency division duplex (FDD) frame structure.

The first FDRA field is denoted as FDRA 1, the first MCS field is denoted as MCS 1, and the first PDSCH transmission is denoted as PDSCH 1. The second FDRA field is denoted as FDRA 2, the second MCS field is denoted as MCS 2, and the second PDSCH transmission is denoted as PDSCH 2. The third FDRA field is denoted as FDRA 3, the third MCS field is denoted as MCS 3, and the third PDSCH transmission is denoted as PDSCH 3. The fourth FDRA field is denoted as FDRA 4, the fourth MCS field is denoted as MCS 4, and the fourth PDSCH transmission is denoted as PDSCH 4. According to the present disclosure, the resources allocation and the MCS index for the PDSCH 1 are indicated by the FDRA 1 and the MCS 1 respectively. The resource allocation and the MCS index for the PDSCH 2 are indicated by the FDRA 2 and the MCS 2 respectively. The resource allocation and the MCS index for the PDSCH 3 are indicated by the FDRA 3 and the MCS 3 respectively. The resource allocation and the MCS index for the PDSCH 4 are indicated by the FDRA 4 and the MCS 4 respectively. The remaining parameters are common for all of the PDSCHs 1-4. As shown in FIG. 6, the PDSCHs 1-4 (i.e., the TBs) are continuously transmitted transmissions. In detail, the PDSCHs 1-4 are continuously transmitted back to back. In summary, the TBs are continuously mapped to available slots or mini-slots, and the slots or mini-slots of TBs mapped can be consecutive or non-consecutive.

It is noted that the embodiment in FIG. 6 can also be used for a TDD frame structure and PUSCH transmissions.

When the sizes of multiple TBs are the same, all the parameters for the multiple TBs are the same. Accordingly, the number of the TBs needs to be determined.

In one embodiment, radio resource control (RRC) configures a number of the TBs.

In another embodiment, RRC configures a plurality of numbers of the TBs, and MAC-CE indicates one of the numbers of TBs to the UE.

In yet another embodiment, RRC configures a plurality of numbers of the TBs, and DCI indicates one of the numbers of TBs to the UE. Alternatively, the DCI indicates a number of the TBs to the UE directly.

For a DCI scheduling multiple PDSCHs (i.e., multiple TBs) transmissions, the hybrid automatic repeat request-acknowledgement (HARQ-ACK) of each PDSCH feedback for a UE should be determined. In Release 15/16, DCI only schedules a TB, and a resource for HARQ-ACK feedback is configured. When a single DCI scheduling multiple PDSCHs is enabled, each PDSCH should feedback HARQ-ACK. In the present disclosure, a new field in DCI is used to indicate resources of multiple PUCCHs and PDSCH-to-HARQ_feedback timing However, the capability of DCI is decreased due to increasing of the DCI size. Thus, an implicit way to determine the resources of the PUCCHs and the PDSCH-to-HARQ_feedback timing is proposed. The resource of each PUCCH and the PDSCH-to-HARQ_feedback timing for each PDSCH transmission are determined based on a PUCCH resource indicator and a PDSCH-to-HARQ_feedback timing in DCI respectively. The HARQ_feedback timing for each PDSCH is the PDSCH reception ending slot N adding k, where k is a value indicated by PDSCH-to-HARQ_feedback timing in DCI, and the resource of the PUCCHs for each PDSCH within a slot are the same.

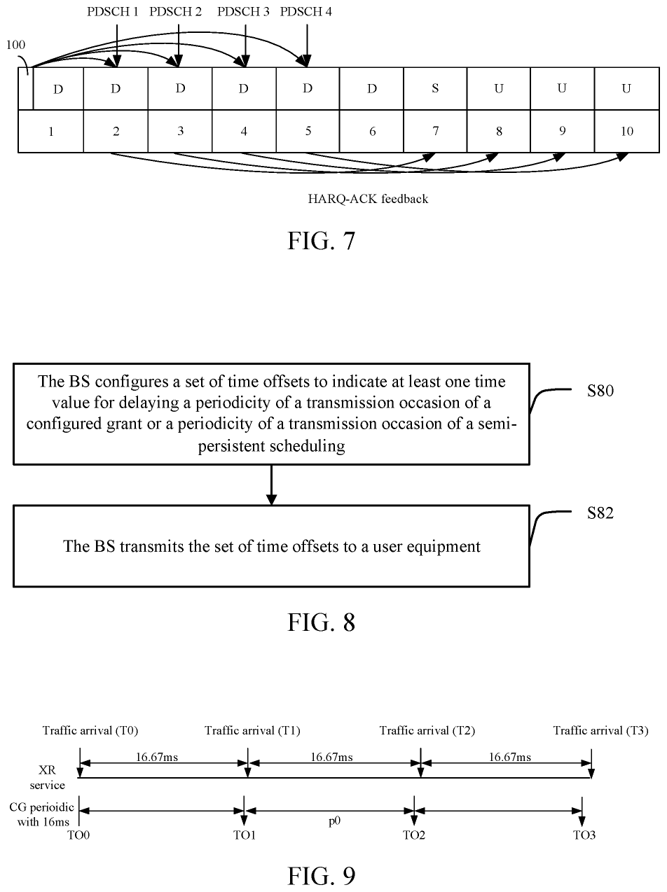

Please refer to FIG. 7. FIG. 7 is a schematic diagram showing HARQ feedbacks for multiple PDSCHs.

A numeral 100 denotes as a DL DCI, which schedules 4 PDSCH transmissions. The PDSCH-to-HARQ_feedback timing is indicated as 5. Then, the HARQ_feedback timing for PDSCH 1 is on slot 7 (2+5), the HARQ_feedback timing for PDSCH 2 is on slot 8 (3+5), the HARQ_feedback timing for PDSCH 3 is on slot 9 (4+5), and the HARQ_feedback timing for PDSCH 4 is on slot 10 (5+5). The resources of the PUCCHs for PDSCH HARQ feedback within each slot are the same.

In summary, the TBs are downlink transmissions, the HARQ feedback for each TB transmission is determined based on DCI indication, and a HARQ feedback occasion is based on a value of PDSCH-to-HARQ_feedback timing and the ending slot of each TB.

By configuring several fields with a varying size in DCI for a plurality of transport blocks (TBs), the technical problem that the DCI overhead is large when an XR transmission is based on a DG can be solved.

It has been agreed that 60 frames per second (fps) is a baseline for both downlink (DL) and uplink (UL) video streams. Furthermore, 30 fps, 90 fps as well as 120 fps can be also optionally evaluated. Based on the formula of arrival time of a packet, corresponding periodicities are {33.33 ms, 16.67 ms, 11.11 ms, 8.33 ms}. In other word, the periodicity of an XR service is not an integer time of 1 ms. In Release 15/16, {10 ms, 20 ms, 32 ms, . . . ,640 ms} for semi-persistent scheduling (SPS) is supported, {sym2, sym7, sym1x14, sym2x14, sym4x14, sym5x14, sym8x14, sym10x14, sym16x14, sym20x14, sym32x14, sym40x14, sym64x14, sym80x14, sym128x14, sym160x14, sym256x14, sym320x14, sym512x14, sym640x14, sym1024x14, sym1280x14, sym2560x14, sym5120x14} for configured grant (CG) is supported. It is easy to observe that the periodicities of XR/CG are not matched, and the periodicities of XR/SPS are not matched. In other word, there is a gap between an XR service arrival and the periodicity of CG, and there is a gap between an XR service arrival and the periodicity of SPS.

In addition, there exists jitter characteristic for an XR traffic arrival. However, the periodicity of semi-persistent scheduling (SPS) in the current specification can only be an integer number of slots. That is, there is a gap between an XR service arrival and an SPS periodicity. In addition, a configured grant (CG) has similar problems.

Please refer to FIG. 8. FIG. 8 is a schematic diagram showing a wireless communication method executable in a base station (BS) according to an embodiment of the present disclosure for solving the problem that there is a gap between an XR service arrival and an SPS periodicity.

In step S80, the BS configures a set of time offsets to indicate at least one time value for delaying a periodicity of a transmission occasion of a configured grant (CG) or a periodicity of a transmission occasion of a semi-persistent scheduling (SPS).

In step S82, the BS transmits the set of time offsets to a user equipment (UE).

The method of the present embodiment is used to solve the gap between the periodicity of CG/SPS and XR service arrival.

Please refer to FIG. 9. FIG. 9 is a schematic diagram showing a gap between a CG periodicity and an XR service arrival according to an embodiment of the present disclosure.

Taking a CG with 16 ms periodicity and 60 frames per second for an XR service as an example. The XR service traffic arrival at each 16.67 ms (60 fps). T0 is denoted as a first packet arrival time, T1 is denoted as a second packet arrival time, T2 is denoted as a third packet arrival time, T3 is denoted as a fourth packet arrival time. The periodicity for the CG is 16 ms. A first transmission occasion is denoted as TO0. A second transmission occasion is denoted as TO1. A third transmission occasion is denoted as TO2. A fourth transmission occasion is denoted as TO3.

The arrival time of the first packet of the XR service is align with the first transmission occasion of the CG. Then, the second packet of the XR service is arrived at T1. A nearest transmission occasion of the CG is TO2. A 15 ms align time is required, and this causes large delay. Thus, a set of time offsets can be configured to the UE. The set of time offsets include at least one value. Then, the start of each transmission occasion is added by the a time offset within the set of time offsets. Taking a set of time offsets having only one value as an example, when the set of time offsets is configured as {1 ms}, the start of each transmission occasion is be added by a time offset within the set of time offsets (excluding or including the first transmission occasion). In other word, the start of transmission occasion is delayed for 1 ms. The transmission occasion is the first transmission occasion within a periodicity no matter the CG/SPS being enabled or disabled repetition.

In some embodiments, the granularity of each time offset is {ms}, {symbol}, {slot}, {repetition}, or {transmission occasion}.

In some embodiments, a set of time offsets are associated to a set of CG/SPS transmission occasions. Each element within the set of CG/SPS transmission occasions is associated an element within a set of time offsets. The relationship between the transmission occasions and the set of time offsets is in order or out of order. The number of the elements within the set of transmission occasions is equal to the size of the set of time offsets when the first transmission occasion start is not delayed, or the number of the elements within the set of transmission occasions is equal to the size of the set of time offsets when the start of first transmission occasion is delayed. Taking the first transmission occasion having no offset as an example. The set of time offsets are configured as {1,2,3}. The granularity of each time offset is ms. Then, the second transmission occasion within the set of SPS/CG transmission occasions is added by the time offset 1, the third transmission occasion within the set of SPS/CG transmission occasions is be added by the time offset 2, and the fourth transmission occasion within the set of SPS/CG transmission occasions is added by the time offset 3. That is, the transmission occasion of the CG or the transmission occasion of the SPS is associated with a time offset within the set of the time offsets in order.

In some embodiments, the set of time offsets are configured by RRC signaling. In some embodiments, an information element (IE) which includes the set of time offsets can be added in configuredgrantconfig or sps-config. In some embodiments, a medium access control element (MAC-CE) can indicate the set of time offsets to the UE. In some embodiments, DCI can indicate the set of time offsets to the UE.

By configuring a set of time offsets to indicate at least one time value for delaying a periodicity of a transmission occasion of a CG or a periodicity of a transmission occasion of an SPS, the technical problem that there is a gap between an XR service arrival and an SPS (or CG) periodicity can be solved.

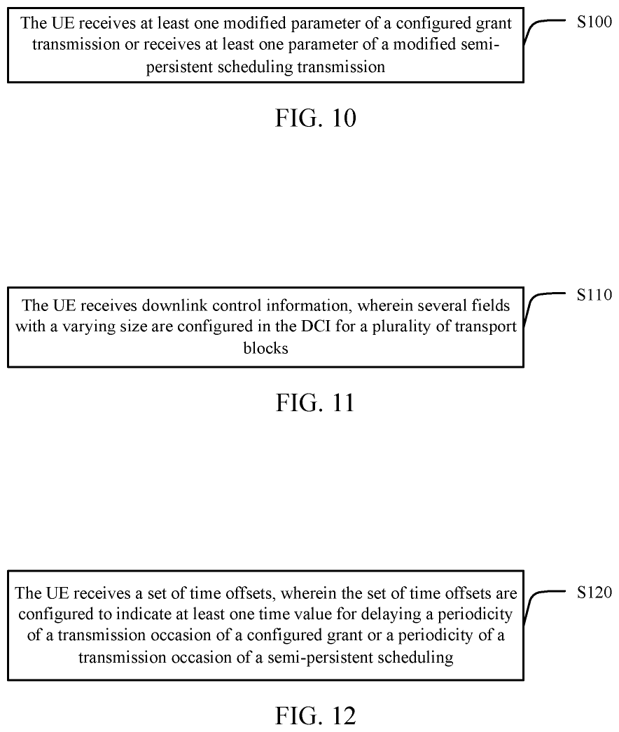

Please refer to FIG. 10. FIG. 10 is a schematic diagram showing a wireless communication method executable in a user equipment (UE) according to an embodiment of the present disclosure.

In step S100, the UE receives at least one modified parameter of a configured grant (CG) transmission or receives at least one parameter of a modified semi-persistent scheduling (SPS) transmission.

Detailed descriptions can be referred to the descriptions in FIG. 3 and are not repeater herein.

Please refer to FIG. 11. FIG. 11 is a schematic diagram showing a wireless communication method executable in a user equipment (UE) according to an embodiment of the present disclosure.

In step S110, the UE receives downlink control information (DCI), wherein several fields with a varying size are configured in the DCI for a plurality of transport blocks (TBs).

Detailed descriptions can be referred to the descriptions in FIG. 4 and are not repeater herein.

Please refer to FIG. 12. FIG. 12 is a schematic diagram showing a wireless communication method executable in a user equipment (UE) according to an embodiment of the present disclosure.

In step S120, the UE receives a set of time offsets, wherein the set of time offsets are configured to indicate at least one time value for delaying a periodicity of a transmission occasion of a configured grant (CG) or a periodicity of a transmission occasion of a semi-persistent scheduling (SPS).

Detailed descriptions can be referred to the descriptions in FIG. 8 and are not repeater herein.

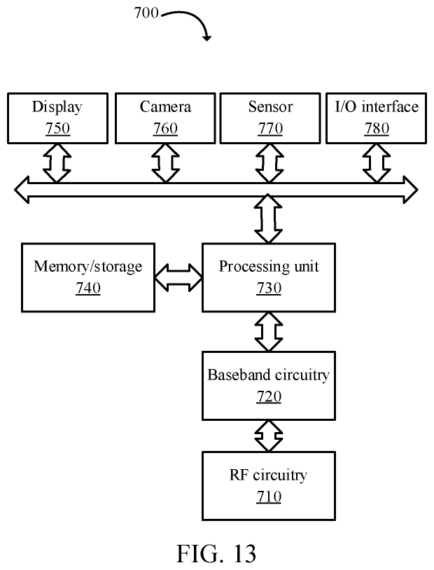

Please refer to FIG. 13. FIG. 13 is a block diagram of a system 700 for wireless communication according to an embodiment of the present disclosure. Embodiments described herein may be implemented into the system using any suitably configured hardware and/or software. FIG. 13 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system. The RF circuitry 710, baseband circuitry 720, processing unit 730, memory/storage 740, display 750, camera 760, sensor 770, and I/O interface 780 are well-known elements in the system 700 such as, but not limited to, a laptop computing device, a tablet computing device, a netbook, an ultrabook, a smartphone, etc. In addition, the instructions as a software product can be stored in a readable storage medium in a computer. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The embodiment of the present disclosure is a combination of techniques/processes that can be adopted in 3GPP specification to create an end product.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method executable in a base station (BS), comprising:
modifying at least one parameter of a configured grant (CG) transmission or modifying at least one parameter of a semi-persistent scheduling (SPS) transmission; and
configuring the at least one modified parameter of the CG transmission to a user equipment (UE) or configuring the at least one modified parameter of the SPS transmission to the UE.

2. The wireless communication method of claim 1, wherein for a type 1 CG transmission, a medium access control element (MAC-CE) is used to modify the at least one parameter of the type 1 CG transmission.

3. The wireless communication method of claim 1, wherein for a type 1 CG transmission, a new radio network temporary identifier (RNTI) scrambled downlink control information (DCI) format is used to modify the at least one parameter of the type 1 CG transmission.

4. (canceled)

5. The wireless communication method of claim 1, wherein for a type 2 CG or SPS transmission, a medium access control element (MAC-CE) is used to modify the at least one parameter of the type 2 CG or SPS transmission.

6. (canceled)

7. A wireless communication method executable in a base station (BS), comprising:
configuring several fields with a varying size in downlink control information (DCI) for a plurality of transport blocks (TBs); and
transmitting the DCI to a user equipment (UE).

8. The wireless communication method of claim 7, wherein the fields at least include a resource allocation field, and resource allocations of the TBs are respectively indicated by an independent part of the resource allocation field in the DCI.

9. The wireless communication method of claim 7, wherein the plurality of TBs are configured with fixed fields within the DCI, and the number of the TBs is indicated by radio resource control (RRC), a medium access control element (MAC-CE) or the DCI.

10. The wireless communication method of claim 9, wherein the TBs are continuously mapped to available slots or mini-slots, and the slots or mini-slots of TBs mapped can be consecutive or non-consecutive.

11. The wireless communication method of claim 7, there is a combination between the several fields with the varying size in the DCI and the TBs.

12. The wireless communication method of claim 7, wherein the TBs are downlink transmissions, hybrid automatic repeat request (HARQ) feedback for each TB transmission is determined based on DCI indication, and a HARQ feedback occasion is based on a value of PDSCH-to-HARQ_feedback timing and an ending slot of each TB.

13. The wireless communication method of claim 12, wherein resource of the HARQ feedback for each TB is the same within a slot.

14-25. (canceled)

26. A base station (BS), comprising:
a transceiver; and
a processor connected with the transceiver and configured to execute operations comprising:
configuring several fields with a varying size in downlink control information (DCI) for a plurality of transport blocks (TBs); and
transmitting the DCI to a user equipment (UE).

27. The base station of claim 26, wherein the fields at least include a resource allocation field, and resource allocations of the TBs are respectively indicated by an independent part of the resource allocation field in the DCI.

28. The base station of claim 26, wherein the plurality of TBs are configured with fixed fields within the DCI, and a number of the TBs is indicated by radio resource control (RRC), a medium access control element (MAC-CE) or the DCI.

29. The base station of claim 28, wherein the TBs are continuously mapped to available slots or mini-slots, and the slots or mini-slots of TBs mapped can be consecutive or non-consecutive.

30. The base station of claim 26, wherein there is a combination between the several fields with the varying size in the DCI and the TBs.

31. The base station of claim 26, wherein the TBs are downlink transmissions, hybrid automatic repeat request (HARQ) feedback for each TB transmission is determined based on DCI indication, and a HARQ feedback occasion is based on a value of PDSCH-to-HARQ_feedback timing and an ending slot of each TB.

32. The base station of claim 31, wherein resource of the HARQ feedback for each TB is the same within a slot.

33-41. (canceled)

42. The wireless communication method of claim 7, wherein the TBs are physical downlink shared channel (PDSCH) transmissions or physical uplink shared channel (PUSCH) transmissions, and sizes of the TBs are the same, parameters for the TBs are the same, and radio resource control (RRC) configures a number of the TBs.

43. The base station of claim 26, wherein downlink shared channel (PDSCH) transmissions or physical uplink shared channel (PUSCH) transmissions, and sizes of the TBs are the same, parameters for the TBs are the same, and radio resource control (RRC) configures a number of the TBs.
